(19) United States
(12) Patent Application Publication
(10) Pub. No.: US 2012/0276900 A1
(43) Pub. Date: Nov. 1, 2012

(54) ENHANCING CELLULAR NETWORKS VIA AN ADJUSTABLE HANDOVER BOUNDARY

(75) Inventors: Paul M. Stephens, Swindon (GB); Swaminathan A. Anantha, Round Lake, IL (US); Walter Featherstone, Swindon (GB); John Mathews, Swindon (GB); Peter P. Randall, Lechlade-on-Thames (GB)

(73) Assignee: MOTOROLA SOLUTIONS, INC., Schaumburg, IL (US)

(21) Appl. No.: 13/095,363

(22) Filed: Apr. 27, 2011

(51) Int. Cl. H04W 36/00

(52) U.S. Cl. 455/436

(57) ABSTRACT

A method for handing off handset in a mobile communication network that defines at a base station (110) an adjusted handover boundary (106) different from a default handover boundary (104) between the base station (110) and a different base station (116). Handover adjustment parameters can be conveyed (120) within messages to user equipment (UE) (112) within range (124) of the base station. The handover adjustment parameters can provide specifics for handover permitting the user equipment (UE) (120) receiving the messages to perform handover operations (166) in accordance with the adjusted handover boundary (106) instead of the default handover boundary (104). The handover adjustment parameters can increment the cell individual offset (CIO) (212) when adjusting for “too late” (210) handover conditions. The handover adjustment parameters decrease the cell individual offset (CIO) (222) when adjusting for “too early” (220) handover conditions.

### FIELD OF THE INVENTION

The present invention relates to the field of self-optimizing networks and, more particularly, to enhancing cellular network handover utilizing a dynamic boundary configuration.

### BACKGROUND

Within current cellular networks (e.g., 3G, pre-4G, and 4G networks), mobility robustness optimization (MRO) plays a key factor in maintaining seamless service throughout the network. MRO can affect critical tasks such as performing handover operations necessary to sustain connectivity between a user equipment (e.g., mobile phone) to the cellular network. The scope of MRO can include reducing the number of handover related radio link failures. MRO can often include optimization of handover parameters by system operators via focused drive-testing, detailed system log collection, and post-processing. Incorrect handover parameter settings can negatively affect user experience and waste network resources by causing handover failures, Radio Link Failures (RLF), and the “ping-pong” effect (i.e., where a device is continuously and rapidly handed back-and-forth between two base stations).

### SUMMARY

One embodiment includes a method for handing off handset in a mobile communication network that defines at a base station an adjusted handover boundary different from a default handover boundary between the base station and a different base station. Handover adjustment parameters can be conveyed within messages to user equipment (UE) within range of the base station. The handover adjustment parameters can provide specifics for handover permitting the user equipment (UE) receiving the messages to perform handover operations in accordance with the adjusted handover boundary instead of the default handover boundary. The handover adjustment parameters can increment the cell individual offset (CIO) when adjusting for “too late” handover conditions. The handover adjustment parameters decrease the cell individual offset (CIO) when adjusting for “too early” handover conditions.

One embodiment includes a system for a base station node (eNodeB) of a long term evolution (LTE) of a mobile telecommunication system. In the system, the base station can include at least one transmitter for wirelessly transmitting digitally encoded content to user equipment (UE) via radio frequency signals over the long term evolution (LTE) compliant network. The base station can also include at least one receiver for wirelessly receiving digitally encoded content from user equipment (UE) via radio frequency signals over the long term evolution (LTE) compliant network. The base station can also include computer program instructions digitally encoded in at least one storage medium, wherein the computer program instructions implement a self-organizing network (SON) automatic neighbor relationship (ANR) function to resolve a cell individual offset oscillation.

Another embodiment can include a method for enhancing handover. In this aspect, a base station node of a wireless mobile telecommunication system can trigger a set of user equipment (UE) within radio frequency range of a base station node to determine neighbor base station nodes also in radio frequency range of the corresponding user equipment, wherein the base station node performs the triggering. The base station node can be a long term evolution (LTE) cell of wireless mobile telecommunication system configured to periodically sample a set of user equipment configured to measure the cell-offset of the neighbor base station nodes. At the base station node, responses from the set of user equipment can be received and the base station can detect a handover resolution failure based on the cell-offset.

### BRIEF DESCRIPTION OF THE SEVERAL VIEWS OF THE DRAWINGS

FIG. 1 is a block diagram illustrating a system for enhancing cellular network handover utilizing an adjusted handover boundary in accordance with an embodiment of the inventive arrangements disclosed herein.

FIG. 2 shows a process for adjusting user interface handoff using a cell individual offset (CIO) in accordance with an embodiment of the inventive arrangements disclosed herein.

FIG. 3 is a schematic diagram illustrating a base station node and a mobile device in accordance with an embodiment of the inventive arrangements disclosed herein.

### DETAILED DESCRIPTION

Current 3^{rd} Generation Partnership Project (3GPP) standards have defined general Mobility Robustness (MR) as “Too Late Handover,” “Too Early Handover,” or “Wrong Cell.” These standards do not describe solution implementations. Current descriptions of Mobility Robustness assume that a single dominant handover route exists between base stations. Presently, mobility robustness optimization (MRO) resolves to a single configuration from a source base station to a target base station.

In one relatively common scenario, where there is a long border between two adjacent cells (e.g., base stations) within the cellular network, there can be different transition points between the cells. Frequently, one transition point along the long border can suffer from a too late handover condition, while another could suffer from a too early condition. This represents a real-world deviation or anomaly compared to existing MRO techniques and practices.

In accordance with various embodiments, an apparatus and techniques are provided herein for enhancing cellular network handover utilizing an adjusted handover boundary. In one embodiment, the apparatus and techniques leverage a 3GPP compliant Automatic Neighbor Relationship (ANR) function in a novel way. User equipment (UE) collected metrics can be utilized to determine transition points within a cell which can result in “too late” or “too early” handover scenarios. Then adjustments can be made at these transmissions points along a long border between adjacent cells to adjust for the “too late” or “too early” conditions.

In one embodiment, the collected metrics can be analyzed to determine corrections which can be communicated from a base station to a user equipment (UE) to dynamically assist with a handover procedure. In one embodiment, a base station can automatically convey radio resource control (RRC) configuration to user equipment (UE). The configuration can be utilized to perform a handover from one cell to a neighbor cell. That is, dynamically altering an RRC configuration can enable a UE to employ different reporting configurations in different parts of a cell where conflicting conditions exist. Thus, UE handover thresholds and conditions can be adjusted at the UE, to delay handover at a transition point (in the case of a transition point that would otherwise be “too early”) or to conduct an earlier handover at a transition point (in the case of a transition point that would otherwise be “too late”).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

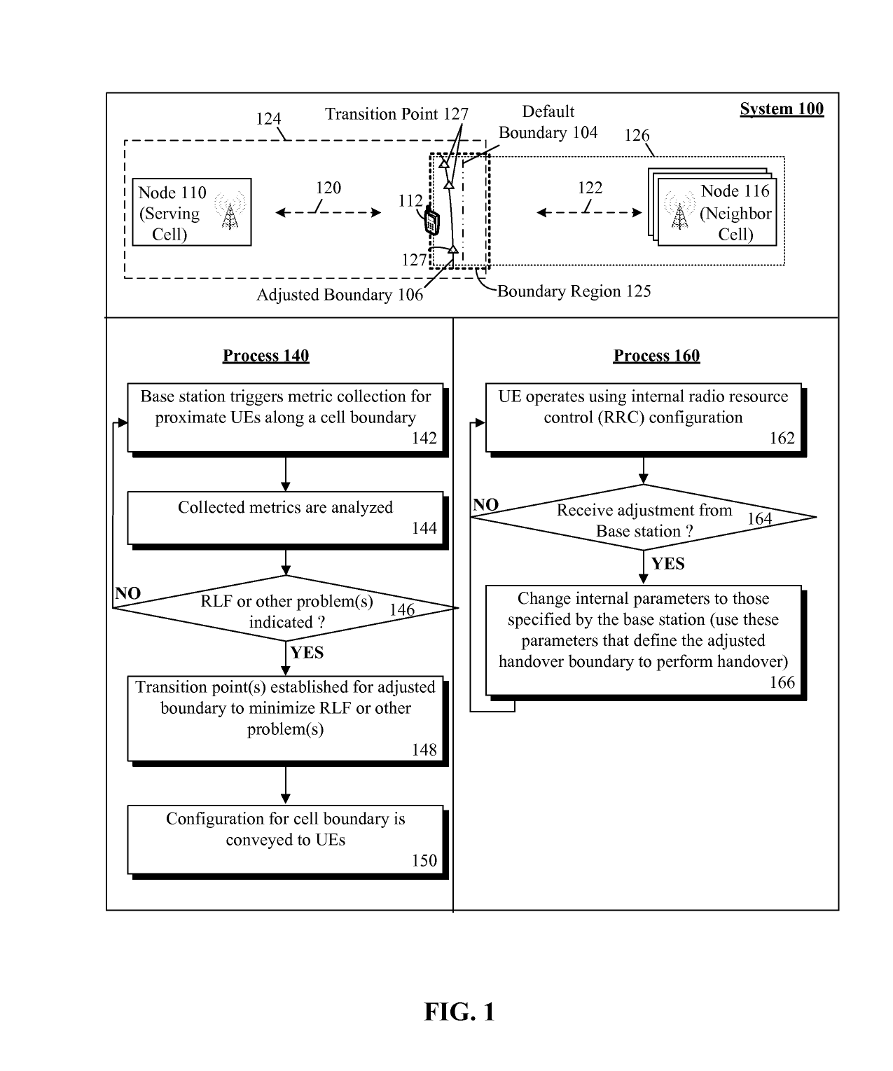

FIG. 1 is a block diagram illustrating a system 100 for enhancing cellular network handover utilizing an adjusted handover boundary in accordance with an embodiment of the inventive arrangements disclosed herein.

The system 100 can be a mobile telecommunication network having base station nodes 110, 116. Each base station node 110, 116 can provide coverage for a station specific region, such as region 124 for node 110 and region 126 for node 116. These regions 124 and 126 can overlap, as shown by boundary region 125. Specific points can be defined within the boundary region 125, referred to as transition points 127. At these transition points 127 conflicting conditions can exist, which would result in “too early” or “too late” handoffs at these transition points 127 assuming no corrections are made for these conflicting conditions.

In system 100, base stations (node 110 or 116) can determine the transition points 127 and suitable adjustments to be made. These determinations can be based at least in part on data (e.g., metrics) gathered from user equipment (UE) within their respective regions 124, 126. Adjustment messages can be sent to the UE, such as UE 112, which causes UE 112 initiated handoffs to be adjusted. These adjustments can effectively shift a handover boundary between the nodes 110, 116. For example, the adjustments can shift the handover boundary from default boundary 104 to adjusted boundary 106. In one embodiment, the adjusted boundary 106 can be dynamic, in that it can be continuously adjusted based on dynamic conditions.

The technique described herein is flexible enough to accommodate any shape of an adjusted boundary 106. For example, the handover boundary can be adjusted (e.g., adjusted boundary 106) to prevent excessive handoffs across a highway, which curves across or near the default boundary 104, to prevent excessive and unnecessary handoffs, given known geographic considerations. In another example, the handover boundary can be adjusted (e.g., adjusted boundary 106) to account for geographic conditions (e.g., hills, obstructions, zones of RF interference, etc.) near the default boundary 104 to minimize dropped calls, which would otherwise occur more frequently.

The mobile telecommunications network of system 100 can conform to a third generation (3G), pre-fourth generation (pre-4G), and/or fourth generation (4G) for mobile telecommunication networks standards. More specifically, in one embodiment, the mobile communication network can conform to 3rd Generation Partnership Project (3GPP) long term evolution (LTE) standards.

Device 112, which can alternatively be referred to as UE, can be a communication device equipped with a wireless transceiver (e.g., 3G or 4G transceiver) able to connect to and exchange information via the mobile communication network via the nodes 110, 116. Device 112 can include, but is not limited to, a mobile telephone, a two-way radio equipment with cellular capability, a tablet computing device, an e-book reader with cellular capability, a notebook, a netbook, an internet device, a navigation device equipped for cellular communication, and the like. Device 112 can conform to 3GPP specifications and/or derivatives thereof.

In an illustrate use-case based on arrangements shown in 100, device 112 can initially operate within region 124 of node 110. When device 112 enters the boundary region 125, it can be triggered to perform measurements, which produces metrics 120 and/or 122 sent to node 110 and node 116 respectively. The base stations (node 110 and 116) can utilize these metrics 120, 122 to determine parameters associated with a handover procedure.

That is, measurements 120, 122 can be collected and analyzed by node 110 to assist device 112 in target cell selection. These measurements 120,122 permit the identification of the transition points 127, which define the adjusted boundary 106.

Processes 140 and 160 graphically show steps able to be performed by base station nodes 110, 116 and device 112 in accordance with techniques detailed herein. In one embodiment, process 140 and/or 160 can be a function of a self-organizing network (SON) able to resolve handover conflicts.

Process 140 can begin in step 142, where, a base station can trigger metric collection for UEs close to or within boundary region 125. The metrics can include traditional and/or non-traditional metrics such as signal strength of neighbor cells (e.g., node 116). Metrics can conform to measurements and quantities based on neighbor cells within radio frequency range. In step 144, collected metrics can be analyzed to determine if the current handover boundary is optimal.

In step 146, if the analysis indicates a high incident of radio link failure (RFL) or other problems, then the process can progress to step 148, else return to step 142. In step 148, transition point(s) 127 can be established for an adjusted boundary 106 to minimize RLF and/or other problems. In step 150, the configuration can be conveyed to UEs. For example, on detection of an Al entry state, a radio resource control configuration (RCC) can be communicated to the UE with a cell individual offset (CIO) value indicating a “too early” condition or a “too late” condition, which can translate into suitable offsets for adjusting parameters of the UE in accordance with the transition points 127 and the adjusted handover boundary 106.

Process 160 can begin in step 162, where a UE can initially operate using a default radio resource control (RRC) configuration. The default RRC configuration can be manually and/or automatically established. The default RRC configuration can effectively cause handover to occur in accordance with the default boundary 104. In step 164, the UE can optionally receive adjustments from one or more base stations (e.g., nodes 110, 116), where the adjustments define the adjusted handover boundary or a portion thereof. When no adjustments are received, the UE can continue to use current RCC configuration parameters for handoff functions, expressed by progressing from step 164 to step 162.

When an adjustment is received, the process 160 can progress to step 166, where the UE can change internal parameters to those specified by the base station (or to match settings conveyed from the base station). That is, internal parameters can be adjusted within the UE consistent with the adjusted handover boundary 106.

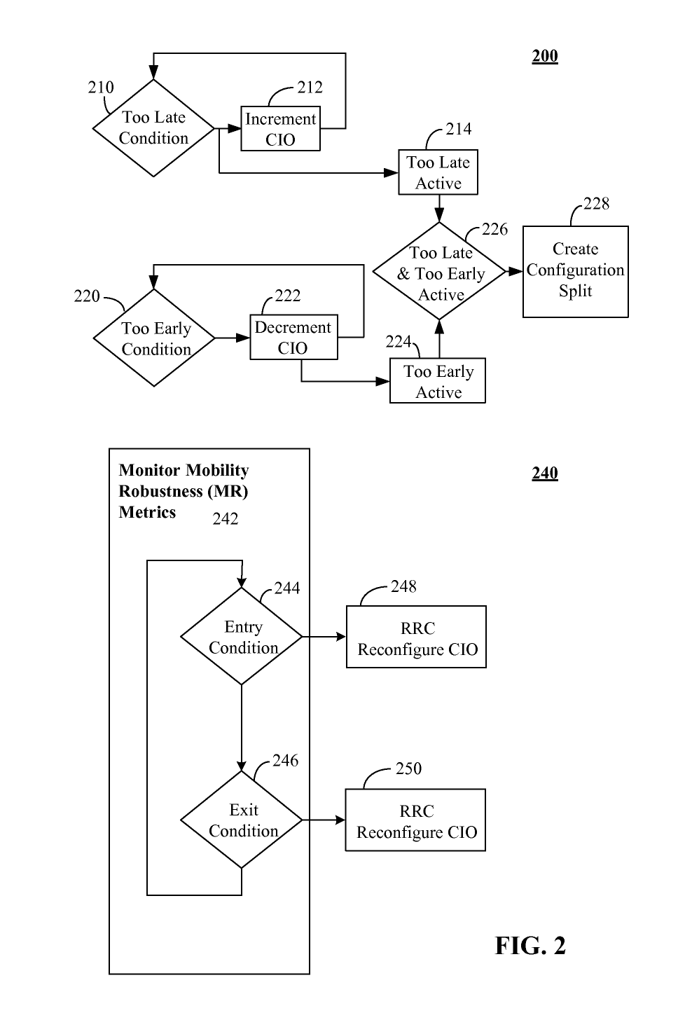

FIG. 2 shows a process 200 for adjusting user interface handoff using a cell individual offset (CIO) in accordance with an embodiment of the inventive arrangements disclosed herein. The process 200 is performed within a single base station, such as base station 110 of system 100. The process 200 can result from the base station detecting an entry condition 244 and/or exit condition 246, where conveyance of these conditions 244, 246 can result from receiving a message from a UE, which indicates the occurrence of a transition event across a boundary (e.g., adjusted boundary 106, for example). The base station can send results of the process 200 to UE in a message, which is shown by the sending of RRC reconfigure CIO message 248 and 250. Thus, the process 200 (detection of “too early” or “too late” conditions) occurs within a base station responsive to condition 244 and/or 246 and results in a message being sent to UE to reconfigure CIO by an amount determined by step 212, 222.

More specifically, the flowchart 200 can represent on flow for adjusting the internal parameters, where a base station sends a “too early” or “too late” message to UE. Scope of the disclosure is not to be limited to details expressed in flowchart 200, as flowchart 200 is provided for illustrative purposes to show of one contemplated implementation.

As shown in flowchart 200, when a “too late” condition is detected, as indicated by a flow from step 210 to step 212, a CIO value can be increased. That is, a base station can send an RRC configuration with a CIO value of “too early”. A “too active” flag can also be set to TRUE or active, as shown by step 214.

When a “too early” condition is detected, as indicated by a flow from step 220 to step 222, a CIO value can be decreased. A “too early” flag can also be set to TRUE or active, as shown by step 224.

When both “too late” and “too early” conditions exist simultaneously between a base station node and a neighbor (shown by progressing from step 226 to step 228), an additional reporting configuration can be established with a value set at the midpoint between the highest and lowest measurements received. In one embodiment, this new reporting configuration can have a hysteresis providing at least 2 db of separation between an entry state and an exist state.

Process 240 shows a flow for a base station to selectively convey the “too early” and “too late” messages to UE. The base station can monitor all received mobility robustness (MR) metrics 242 for entry conditions 244 and exit conditions 246. In an entry condition 244 (detection of an A1 entry state, for example), it can be assumed that a UE is operating in a region more likely to experience a “too early” condition. Thus, a RRC configuration can be sent to the UE with a CIO value for too early, as shown by step 248. In one embodiment, a “too early” condition can be characterized by medium to high serving node and neighbor node strengths.

In an exit condition 244 (detection of an A2 state where the serving node is worse than a previously configured threshold), it can be assumed that a UE is operating in a region more likely to experience a “too late” condition. Thus, a RRC configuration can be sent to the UE with a CIO value for “too late”, as shown by step 250. In one embodiment, a “too late” condition can be characterized by low serving node and neighbor node strengths.

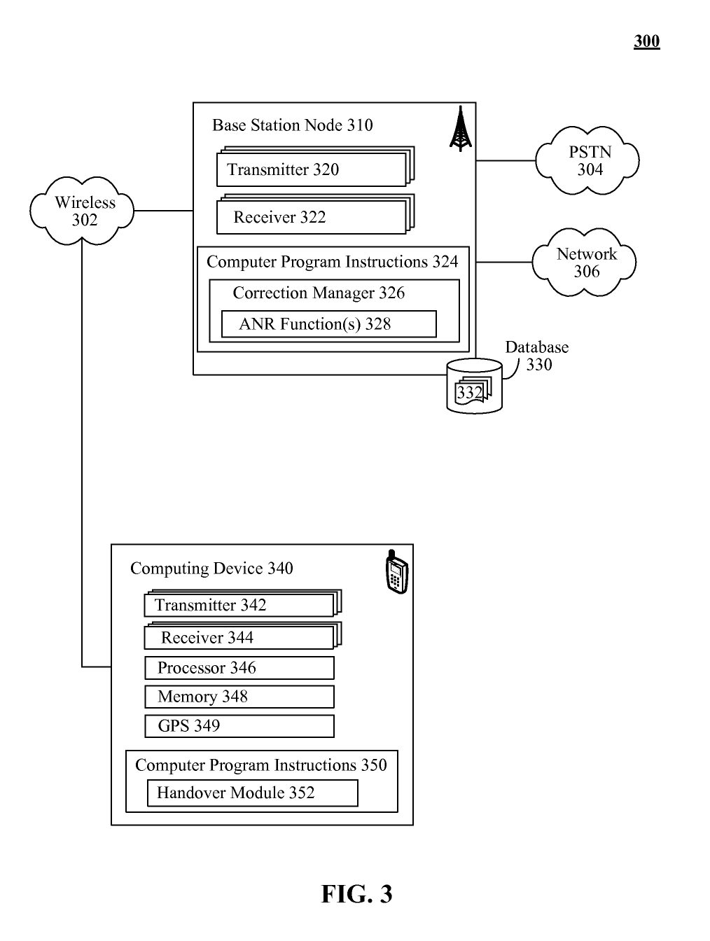

FIG. 3 is a schematic diagram 300 illustrating a base station node and a mobile device 340 in accordance with an embodiment of the inventive arrangements disclosed herein. In one embodiment, nodes 110, 116 of FIG. 1 can be implemented in accordance with specifics expressed for node 310. Further, the device 112 can be implemented in accordance with specifics expressed for device 340.

The base station can include a set of equipment that facilitates wireless communication (over wireless network 302) between user equipment (UE) (e.g., mobile device 340) and a network, such as the public switched telephone network (PSTN) 304 and/or network 306. In various embodiments, the base station 310 can be referred to as a base transceiver station (BTS), a cell site, a radio base station (RBS), node B (in 3G networks), a base station, eNodeB or eNB or enhanced node B (in LTE networks). In one embodiment, the node 310 can be guaranteed to follow 3rd Generation Partnership Project (3GPP) standards. Node 310 may or may not be in compliance with 4G standards. That is, in absence to the handover resolution actions detailed herein, radio link failures arising from handover conflicts will situationally arise in the mobile telecommunications network within which node 310 is utilized.

The base station node 310 can include one or more transmitters 320 and one or more receivers 322. Each transmitter 320 can transmit information from the base station node 310 to the wireless network 302 and/or from the base station node to network 304 and/or network 306. Each receiver 322 can receive information from network 302, 304, and/or 306.

The base station can include a set of computer program instructions 324 that are stored on at least one storage medium and that are able to be executed by one or more processors. The computer program instructions 324 can be implemented within software, firmware, or printed circuitry. Sets of computer program instructions 324 can implement a correction manager 326. The correction manager 326 can trigger one or more actions responsive to detection of handover resolution failure.

The correction manager 326 can detect the existence of a handover resolution failure among neighboring nodes. In one embodiment, the correction manager 326 can utilize one or more Automatic Neighbor Relationship (ANR) functions 328. Specifically an ANR function 328 can be associated with any criteria (e.g., Al) associated with reporting configuration within the 3GPP specification. Specifically, information about neighboring nodes can be stored within a memory represented by the neighbor database 330.

Database 330 can include a unique identifier for a node (e.g., data element 332) associated with a location (e.g., geographic coordinates), flags (e.g., “too early”, “too late”), and the like. Information in the neighbor database 330 can be constantly updated as the node 310 receives measurement reports from UEs (e.g., process 140 and/or 160).

The database 330 can include hardware (e.g., physical storage medium(s)) for storing the PCI information and can optionally include information management software. Any data storage format, set of data structures, storage convention can be utilized by the neighbor database 330, which is not to be limited to any one specific protocol or storage methodology.

In one embodiment, the correction manager 326 can build or update records 332 in a neighbor database 330 of the base station node 310 to indicate an early handoff and a late handoff. In one embodiment, these records 332 of the neighbor database 330 can be queried at the base station node 310 in response to detecting a handover resolution failure. A reporting configuration (created by correction manager 326) can be communicated across wireless network 302 to computing device 340, where computing device 340 (specifically module 352) uses the reporting configuration to modify handover timing of the device 340.

The wireless network 302 can be used convey digitally encoded information wirelessly between mobile devices in range of the base station node 310. In various embodiments, wireless network 302 can conform to a variety of wireless communication technologies, such as Global System for Mobile Communications (GSM), Code division multiple access (CDMA), Wireless local loop (WLL), a wide area network (WAN), WiFi (any of the IEEE 802.11 family of standards), WiMAX (Worldwide Interoperability for Microwave Access), etc. In one embodiment, the wireless network 302 can be 3GPP compliant. In one embodiment, wireless network 302 can include a LTE network.

PSTN network 304 can represent a network of circuit-switched telephone networks. The PSTN 304 can consist of telephone lines, fiber optic cables, microwave transmission links, cellular networks, communications satellites, and undersea telephone cables all inter-connected by switching centers which allows telephones across the world to communicate with each other.

Network 306 can represent a packet switched network. Network 306 can conform to the internet protocol (IP) set of protocols that include a Transmission Control Protocol (TCP) and the Internet Protocol (IP). Network 306 can be public or private. For example network 306 can represent the public internet, a corporate intranet, a virtual private network (VPN), and the like. Data and/or voice (via a Voice Over IP protocol) can be conveyed over network 306.

Device 340 can be referred to as UE, as it includes at least one of a wireless transmitter 342 and wireless receiver 344, which allows the device 340 to connect to wireless network 302. Message conveyances for potential handover failure detection activities can occur over wireless network 302. Additional (and optional) receivers and/or transmitters can be included in device 340, which may permit device 340 to directly connect to network 304 and/or 306 in a wired or wireless manner in various embodiments

The device 340 can include one or more processors 346 and one or more memory 348 components. The set of one or more processors 346 can execute computer program instructions 350 of the device 340. These instructions 350 can represent logic embedded in semiconductor, firmware embedded instructions, and/or software stored on a storage medium of device 340, such as memory 348. Device 340 can optionally include global positioning system (GPS) component able to determine the geographic location of device 340.

Instructions 350 can include a handover module 352. Handover module 352 determines based on these parameters when handover actions are to occur from one node (e.g., base station) to another of a mobile telephony system. The handover module 352 is designed to trigger handover actions when the computing device 340 crosses the adjusted boundary (e.g., boundary 106 of system 100). Thus, the handover module 352 can adjust internal parameters maintained by device 340 to those provided by base station node 310 (as noted by step 166 of process 160, for example).

The flowchart and block diagrams in the FIGS. 1-3 illustrate the architecture, functionality, and operation of possible implementations of systems, methods and computer program products according to various embodiments of the present invention.

The adjustable handover boundary, as defined herein, allows for adjustable handover boundaries, which prevents “too early” and “too late” handovers from occurring, especially across a relatively large boundary region between two base stations. Excessive or incorrect handoffs consume computing resources of the base stations and of the user equipment needlessly. Additionally, “too early” and “too late” handovers result in lower quality communications from an end-user perspective. Thus, the disclosure conserves resources while improving communication quality. An embodiment of the disclosure provides an implementation applicable to the Mobility Robustness (MR) SON feature introduced in 3GPP Release 9. The standards descriptions, unlike the disclosure, does not address the case of experiencing both a “too late” condition and a “too early” condition between the same pair of nodes or base stations. The handoff approach provided by the various embodiments of the disclosure avoids oscillations between two ideal values, thereby avoiding the “ping-pong effect.”

Each block in the flowchart or block diagrams as provided herein may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for handing off handset in a mobile communication network comprising:
defining at a base station an adjusted handover boundary different from a default handover boundary between the base station and a different base station; and
conveying handover adjustment parameters within messages to user equipment (UE) within range of the base station, wherein the handover adjustment parameters provide specifics for handover permitting the user equipment (UE) receiving the messages to perform handover operations in accordance with the adjusted handover boundary instead of the default handover boundary.

2. The method of claim 1, wherein the messages sent from the base station to the UE's are radio resource control (RRC) configurations.

3. The method of claim 1, further comprising:
detecting at the base station “too early” conditions for handoff for a portion of the default handover boundary; and
responsive to the detecting, defining the adjusted handover boundary to conduct handover at a new boundary location that minimizes the “too early” conditions.

4. The method of claim 1, further comprising:
detecting at the base station “too late” conditions for handoff for a portion of the default handover boundary; and
responsive to the detecting, defining the adjusted handover boundary to conduct handover at a new boundary location that minimizes the “too late” conditions.

5. The method of claim 1, further comprising:
collecting metrics at the base station from a plurality of UEs along a boundary region representing overlap between a range of the base station and the range of the different base station; and
utilizing the collected metrics to define the adjusted handover boundary to minimize “too early” and “too late” conditions.

6. The method of claim 1, wherein the handover adjustment parameters cause the UE receiving one of the messages to adjust a cell individual offset (CIO).

7. The method of claim 1, wherein the handover adjustment parameters increment the cell individual offset (CIO) when adjusting for “too late” handover conditions.

8. The method of claim 1, wherein the handover adjustment parameters decrease the cell individual offset (CIO) when adjusting for “too early” handover conditions.

9. The method of claim 1, further comprising:
triggering at the base station, a set of user equipment (UE) within radio frequency range of the base station node to determine neighbor base station nodes, which include the different base station, also in radio frequency range of the corresponding user equipment, wherein the base station node performs the triggering, wherein the base station node is a long term evolution (LTE) cell of wireless mobile telecommunication system configured to periodically sample a set of user equipment configured to measure the cell-offset of the neighbor base station nodes; and
receiving at the base station node responses from the set of user equipment and detecting a handover resolution failure based on the cell-offset, wherein the adjusted handover boundary is established in a manner to minimize handover resolution failure occurrences.

10. The method of claim 1, wherein the base station comprises:
at least one transmitter for wirelessly transmitting digitally encoded content to user equipment (UE) via radio frequency signals over the long term evolution (LTE) complaint network;
at least one receiver for wirelessly receiving digitally encoded content from user equipment (UE) via radio frequency signals over the long term evolution (LTE) compliant network; and
computer program instructions digitally encoded in at least one storage medium, wherein the computer program instructions implement a self-organizing network (SON) automatic neighbor relationship (ANR) function that establishes the adjusted handover boundary and that conveys the handover adjustment parameters within the messages to resolve a cell individual offset oscillation.

11. The method of claim 1, wherein the defining of the adjusted handover boundary and the conveying of handover adjustment parameters within messages are actions performed as during execution of a mobility robustness optimization algorithm, executing upon at least one processor of the base station.

12. A base station node (eNodeB) of a long term evolution (LTE) of a mobile telecommunication system comprising:
at least one transmitter for wirelessly transmitting digitally encoded content to user equipment (UE) via radio frequency signals over the long term evolution (LTE) compliant network;
at least one receiver for wirelessly receiving digitally encoded content from user equipment (UE) via radio frequency signals over the long term evolution (LTE) compliant network; and
computer program instructions digitally encoded in at least one storage medium, wherein the computer program instructions implement a self-organizing network (SON) automatic neighbor relationship (ANR) function to resolve a cell individual offset oscillation.

13. The base station node of claim 12, wherein the computer program instructions define transition points within a boundary region between the base station node and a different base station, where the transition points demarcate a handover boundary for handing user equipment (UE) between the base stations and the different base station.

14. The base station node of claim 12, wherein the computer program instructions define an adjusted handover boundary different from a default handover boundary established between the base station node and a different base stations, where the adjusted handover boundary is a boundary for handing user equipment (UE) between the base stations and the different base station.

15. The base station node of claim 12, wherein the computer program instructions convey radio resource control (RRC) configurations to UEs, which cause the UEs to handover in accordance with the adjusted handover boundary.

16. The base station node of claim 12, wherein the computer program instructions is triggered by at least one of an entry state and an exit state, and wherein the computer program instructions cause the base station to detect a handoff resolution failure by causing a sample of user equipment (UE) to convey metrics of neighboring cells to the base station, which the base station uses to detect handover conflicts.

17. The base station node of claim 12, wherein the ANR function creates a reporting configuration having a value established at a midpoint between the highest and lowest measurement received.

18. The base station node of claim 17, wherein the reporting configuration comprises of a hysteresis providing at least 2 decibels (dB) of separation between the entry and the exit state.

19. A method for detecting handover resolution conflicts comprising:
triggering a set of user equipment (UE) within radio frequency range of a base station node to determine neighbor base station nodes also in radio frequency range of the corresponding user equipment, wherein the base station node performs the triggering, wherein the base station node is a long term evolution (LTE) cell of wireless mobile telecommunication system configured to periodically sample a set of user equipment configured to measure the cell-offset of the neighbor base station nodes;
receiving at the base station node responses from the set of user equipment and detecting a handover resolution failure based on the cell-offset.

20. The method of claim 19, further comprising:
building or updating records in a neighbor database of the base station node to indicate an early handoff and a late handoff;
querying the records of the neighbor database at the base station node in response to detecting the handover resolution failure; and
communicating a reporting configuration in the wireless mobile telecommunication system to modify a user equipment handover timing.
